(19) United States
(12) Patent Application Publication
(10) Pub. No.: US 2014/0305597 A1
(43) Pub. Date: Oct. 16, 2014

(54) SOLUTION OF AROMATIC POLYAMIDE FOR PRODUCING DISPLAY ELEMENT, OPTICAL ELEMENT, OR ILLUMINATION ELEMENT

(71) Applicants: Akron Polymer Systems, Inc., Akron, OH (US); Sumitomo Bakelite Co., Ltd., Shinagawa-ku (JP)

(72) Inventors: Frank W. HARRIS, Boca Raton, FL (US); Dong Zhang, Uniontown, OH (US); Limin Sun, Copley, OH (US); Jiaokai Jing, Uniontown, OH (US); Hideo Umeda, Kobe-shi (JP); Ritsuya Kawasaki, Kobe-shi (JP); Toshihiko Katayama, Kobe-shi (JP); Yusuke Inoue, Kobe-shi (JP); Jun Okada, Kobe-shi (JP); Mizuho Inoue, Kobe-shi (JP); Manabu Naito, Kobe-shi (JP)

(73) Assignees: Akron Polymer Systems, Inc., Akron, OH (US); Sumitomo Bakelite Co., Ltd., Shinagawa-ku (JP)

(21) Appl. No.: 14/252,054

(22) Filed: Apr. 14, 2014

Related U.S. Application Data
(60) Provisional application No. 61/812,000, filed on Apr. 15, 2013.
(60) Provisional application No. 61/886,896, filed on Oct. 4, 2013.

(51) Int. Cl. C08G 69/32; C09D 177/10

(52) U.S. Cl. CPC C08G 69/32; C09D 177/10
USPC 156/701; 428/435; 428/337; 428/339; 524/607; 427/407.2; 427/407.1; 427/162

(57) ABSTRACT

This disclosure, viewed from one aspect, relates to a solution of polyamide comprising: an aromatic polyamide; and a solvent; wherein elastic modulus at 30.0° C. of a cast film formed by applying the solution onto a glass plate is 5.0 GPa or less, and coefficient of thermal expansion (CTE) of the cast film is more than 30 ppm/K, and wherein the aromatic copolyamide comprises at least two repeat units, and at least one of the repeat units has one or more free carboxyl groups.

### CROSS REFERENCE TO RELATED APPLICATIONS

The disclosure is based upon and claims priorities from U.S. Provisional Application Ser. No. 61/812,000 and U.S. Provisional Application Ser. No. 61/886,896, the disclosures of which are hereby incorporated by reference herein in its entirety.

### TECHNICAL FIELD

This disclosure, in one aspect, relates to a solution of polyamide including an aromatic copolyamide and a solvent. The aromatic copolyamide includes at least two repeat units, at least one of the repeat units has one or more free carboxyl groups, and elastic modulus is equal to or smaller than a certain value and coefficient of thermal expansion (CTE) is equal to or larger than a certain value. This disclosure, in another aspect, relates to a laminated composite material including a glass plate and a polyamide resin layer, wherein the polyamide resin layer is laminated onto one surface of the glass plate. The polyamide resin layer is obtained by applying the solution of polyamide on the glass plate, and has elastic modulus that is equal to or smaller than a certain value and coefficient of thermal expansion (CTE) that is equal to or larger than a certain value. This disclosure, in another aspect, relates to a process for manufacturing the solution of polyamide. This disclosure, in another aspect, relates to a process for manufacturing a display element, an optical element or an illumination element, including a step of forming a polyamide film using the solution of polyamide.

### BACKGROUND ART

As transparency is required of display elements, glass substrates using a glass plate have been used as substrates for the elements (JP10311987 (A)). However, for display elements using a glass substrate, problems such as being heavy in weight, breakable and unbendable have been pointed out at times. Thus, the use of a transparent resin film instead of a glass substrate has been proposed.

For example, polycarbonates, which have high transparency, are known as transparent resins for use in optical applications. However, their heat resistance and mechanical strength can be an issue when using them in manufacturing display elements. On the other hand, examples of heat resistant resins include polyimides. However, typical polyimides are brown-colored, and it can be an issue for use in optical applications. As polyimides with transparency, those having a ring structure are known. However, the problem with such polyimides is that they have poor heat resistance.

For polyamide films for use in optical applications, WO 2004/039863 and JP 2008260266(A) each disclose an aromatic polyamide having a diamine including a trifluoro group, which provides both high stiffness and heat resistance.

WO 2012/129422 discloses a transparent polyamide film with thermal stability and dimension stability. This transparent film is manufactured by casting a solution of aromatic polyamide and curing the casted solution at a high temperature. The document discloses that the cured film has a transmittance of more than 80% over a range of 400 to 750 nm, a coefficient of thermal expansion (CTE) of less than 20 ppm/° C., and shows favorable solvent resistance. And the document discloses that the film can be used as a flexible substrate for a microelectronic device.

### SUMMARY

This disclosure, in one aspect, relates to a solution of polyamide including an aromatic polyamide and a solvent. The aromatic polyamide includes at least two repeat units, at least one of the repeat units has one or more free carboxyl groups, and elastic modulus at 30° C. of a cast film formed by applying the solution onto a glass plate is 5.0 GPa or less, and coefficient of thermal expansion (CTE) of the cast film is more than 30.0 ppm/K.

This disclosure, in another aspect, relates to a laminated composite material including a glass plate and a polyamide resin layer. The polyamide resin layer is laminated on one surface of the glass plate, elastic modulus at 30° C. of the polyamide resin layer is 5.0 GPa or less and coefficient of thermal expansion (CTE) of the polyamide resin layer is more than 30.0 ppm/K, and the polyamide resin layer is obtained by applying the solution of polyamide onto the glass plate.

Further, this disclosure, in another aspect, relates to a process for manufacturing a display element, an optical element, or an illumination element, including the step of forming the display element, the optical element, or the illumination element on a surface of the polyamide resin layer of the laminated composite material, wherein the surface is not opposed to the glass plate. Further, this disclosure, in another aspect, relates to a display element, an optical element, or an illumination element manufactured through the process.

### BRIEF DESCRIPTION OF THE DRAWINGS

FIG. 1 is a schematic cross-sectional view showing a configuration of an organic EL element 1 according to one embodiment.

FIG. 2 is a flow chart for explaining a process for manufacturing an OLED element according to one embodiment.

### DETAILED DESCRIPTION

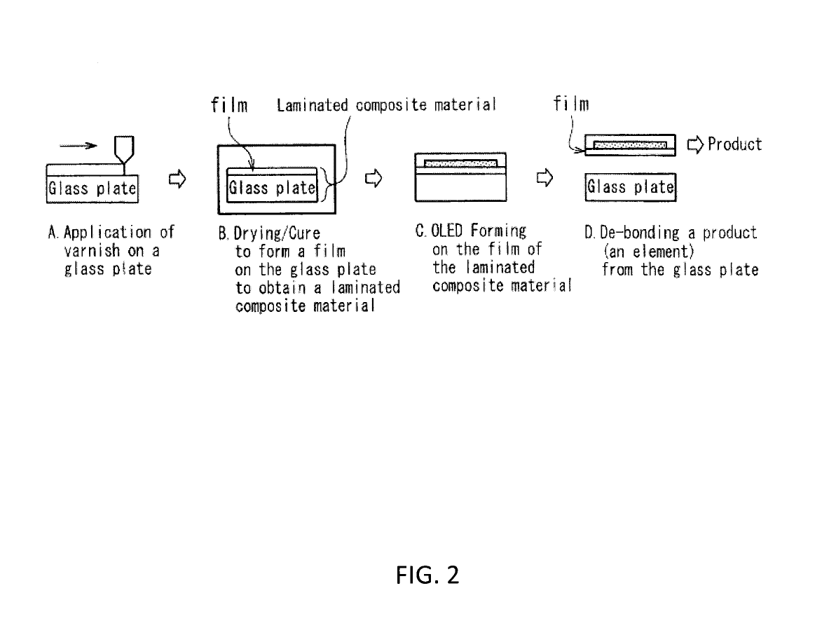

A display element, an optical element, or an illumination element such as an organic electro-luminescence (OEL) or organic light-emitting diode (OLED) is often produced by the process described in FIG. 2. Briefly, a polymer solution (varnish) is applied or casted onto a glass base or a silicon wafer base (step A), the applied polymer solution is cured to form a film (step B), an element such as OLED is formed on the film (step C), and then, the element such as OLED (product) is de-bonded from the base (step D). These days, polyimide film is used as the film in the process in FIG. 2.

In the course of forming a film from the varnish applied onto the glass base in the steps A and B of the process for manufacturing a display element, an optical element, or an illumination element described in FIG. 2, the film may be stretched in the in-plane direction as the film shrinks, and a retardation (Rth) may thus develop in the thickness direction of the film. It is preferable that Rth can be controlled because it may affect the picture quality of a display. For example, in order to prevent a decline in viewing angle of a liquid crystal display, Rth of the film is preferably small. With this problem, it has been found that the use of a polyamide solution, which contains an aromatic polyamide including at least two repeat units and at least one of the repeat units has one or more carboxyl groups as pendant groups, and from which a cast film (obtained by applying the solution onto a glass base) with certain elastic modulus and certain coefficient of thermal expansion can be obtained, allows the control and reduction of Rth of the film (i.e., Rth can be suppressed).

Therefore, the solution of polyamide according to this disclosure includes an aromatic polyamide and a solvent, wherein the aromatic polyamide includes at least two repeat units, at least one of the repeat units has one or more free carboxyl groups, and elastic modulus at 30° C. of a cast film formed by applying the solution onto a glass plate is 5.0 GPa or less and coefficient of thermal expansion (CTE) of the cast film is more than 30.0 ppm/K.

In one or plurality of embodiments, this disclosure relates to a solution of polyamide capable of suppressing Rth of a cast film.

The term “cast film formed by applying the solution onto a glass plate” as used herein refers to a film obtained by applying the solution of polyamide according to this disclosure onto a flat glass base, and drying, and if necessary curing, the applied solution. More specifically, it refers to a film manufactured through a process for forming a film disclosed in Examples.

In terms of suppressing Rth, the solution of polyamide according to this disclosure is one from which a cast film (formed by applying the solution onto a glass plate) having elastic modulus at 30° C. of 5.0 GPa or less is obtained. In one or plurality of embodiments, the elastic modulus at 30° C. is 4.5 GPa or less, 4.0 GPa or less, 3.5 GPa or less, 3.0 GPa or less, less than 3.0 GPa, or 2.8 GPa or less. Further, in one or plurality of embodiments, in terms of using the film in a display element, an optical element, or an illumination element, the solution of polyamide according to this disclosure is one from which a cast film (formed by applying the solution onto a glass plate) having elastic modulus at 30° C. of 0.1 GPa or more or 0.5 GPa or more is obtained. Herein, the elastic modulus at 30° C. of the polyamide film is measured using a dynamic mechanical analyzer, and more specifically, it is measured by a method described in Examples.

In terms of suppressing Rth, the solution of polyamide according to this disclosure is one from which a cast film (formed by applying the solution onto a glass plate) having CTE of more than 30.0 ppm/K is obtained. In one or plurality of embodiments, the CTE is 32.0 ppm/K or more, 34.0 ppm/K or more, 36.0 ppm/K or more, 38.0 ppm/K or more, or 40.0 ppm/K or more. Further, in one or plurality of embodiments, in terms of using the film in a display element, an optical element, or an illumination element, CTE of a cast film formed by applying the solution of polyamide according to this disclosure onto a glass plate is 60.0 ppm/K or less. Herein, the CTE of the polyamide film is measured using a thermal mechanical analyzer, and more specifically, it is measured by a method described in Examples.

As to why setting the elastic modulus at 30° C. and CTE of a cast film formed by applying the solution of polyamide onto a glass plate within the above described ranges allows reduction of Rth, i.e., the control of Rth, the detailed mechanism is not clear but it is assumed as follows. That is, it is believed that the occurrence of molecular orientation of a benzene ring in an aromatic film can be suppressed by increasing the CTE somewhat and reducing the elastic modulus, thereby suppressing the development of Rth. It should be noted that this disclosure may not be interpreted based solely on such a mechanism.

In one or plurality of embodiments, in terms of suppressing Rth and/or setting the elastic modulus at 30° C. and CTE of a cast film formed by applying the solution of polyamide onto a glass plate within the above-described ranges, the ratio of an amount of aromatic monomers having a flexible backbone to a total amount of monomers used for synthesis of the aromatic polyamide in the solution of polyamide is 40.0 mol % or more, 42.0 mol % or more, 45.0 mol % or more, more than 45.0 mol %, 47.0 mol % or more, or 50.0 mol %. Further, in one or plurality of embodiments, in terms of using the film in a display element, an optical element, or an illumination element, the ratio of an amount of aromatic monomers having a flexible backbone to a total amount of monomers used for synthesis of the aromatic polyamide in the solution of polyamide is 95 mol % or less, 90 mol % or less, 80 mol % or less, or 70 mol % or less.

In one or plurality of embodiments, examples of the aromatic monomer having a flexible backbone in this disclosure include an aromatic diamine monomer having a flexible backbone and/or an aromatic diacid dichloride monomer having a flexible backbone.

It can be said that an aromatic diamine monomer having a flexible backbone is an aromatic diamine monomer in which two amino groups are bonded to a bivalent aromatic group (arylene group) at o- or m-position or an aromatic diamine monomer in which two amino groups are bonded to a bivalent aromatic group at a position other than p-position.

Similarly, it can be said that an aromatic dicarboxylic acid dichloride monomer having a flexible backbone is an aromatic dicarboxylic acid dichloride monomer in which two —COCl groups are bonded to a bivalent aromatic group (arylene group) at o- or m-position or an aromatic dicarboxylic acid dichloride monomer in which two —COCl groups are bonded to a bivalent aromatic group (arylene group) at a position other than p-position.

In one or plurality of embodiments, the solution of polyamide according to this disclosure is one from which a cast film (formed by applying the solution onto a glass plate) having retardation (Rth) at 400 nm of thickness direction of 350.0 nm or less, 300.0 nm or less, 250.0 nm or less, 200.0 nm or less, 190.0 nm or less, 180.0 nm or less, 175.0 nm or less, or 173.0 nm or less is obtained. Rth of the polyamide film is calculated using a retardation measurement device, and more specifically, it is measured by a method described in Examples.

In one or plurality of embodiments, in terms of using the film in a display element, an optical element, or an illumination element and suppressing Rth, the aromatic polyamide of the solution of polyamide according to this disclosure may be an aromatic polyamide having repeat units represented by the general formulas (I) and (II).

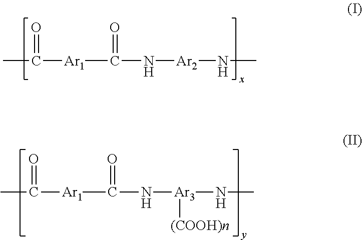

wherein x represents mole % of the repeat structure (I), y represents mole % of the repeat structure (II), x varies from 70 to 99.90, and y varies from 30 to 0.01;

wherein n=1 to 4;

wherein Ar₁ is selected from the group comprising:

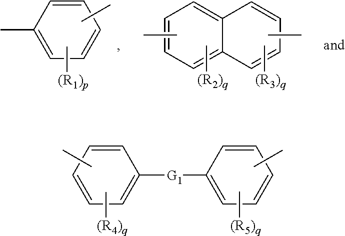

wherein p=4, q=3, and wherein R₁, R₂, R₃, R₄, R₅ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, or substituted aryl such as halogenated aryls, alkyl ester and substituted alkyl esters, and combinations thereof, each R₁ can be different, each R₂ can be different, each R₃ can be different, each R₄ can be different, and each R₆ can be different, G₁ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene;

wherein Ar₂ is selected from the group of comprising:

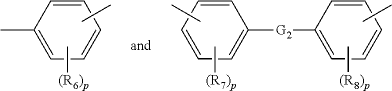

wherein p=4, wherein R₆, R₇, R₈ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, substituted aryl such as halogenated aryls, alkyl ester, and substituted alkyl esters, and combinations thereof, each R₆ can be different, each R₇ can be different, and each R₈ can be different, G₂ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene;

wherein Ar₃ is selected from the group comprising:

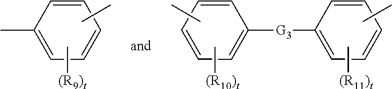

wherein t=1 to 3, wherein R₉, R₁₀, R₁₁ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, substituted aryl such as halogenated aryls, alkyl ester, and substituted alkyl esters, and combinations thereof, each R₉ can be different, each R₁₀ can be different, and each R₁₁ can be different, G₃ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene.

In one or plurality of embodiments of this disclosure, (I) and (II) are selected so that the polyamide is soluble in a polar solvent or a mixed solvent comprising one or more polar solvents. In one or plurality of embodiments of this disclosure, x varies from 70.0 to 99.99 mole % of the repeat structure (I), and y varies from 30.0 to 0.01 mole % of the repeat structure (II). In one or plurality of embodiments of this disclosure, x varies from 90.0 to 99.9 mole % of the repeat structure (I), and y varies from 10.0 to 0.1 mole % of the repeat structure (II). In one or plurality of embodiments of this disclosure, x varies from 91.0 to 99.0 mole % of the repeat structure (I), and y varies from 9.0 to 1.0 mole % of the repeat structure (II). In one or plurality of embodiments of this disclosure, x varies from 92.0 to 98.0 mole % of the repeat structure (I), and y varies from 8.0 to 2.0 mole % of the repeat structure (II). In one or plurality of embodiments of this disclosure, the aromatic polyamide contains multiple repeat units with the structures (I) and (II) where Ar₁, Ar₂, and Ar₃ are the same or different.

In one or plurality of embodiments, in terms of using the film in a display element, an optical element, or an illumination element and suppressing Rth, the solution of polyamide according to this disclosure is one obtained through or may be obtained through a manufacturing process including the following steps. However, the solution of polyamide according to this disclosure is not limited to the one manufactured through the following manufacturing process.

a) dissolving at least one aromatic diamine in a solvent;

b) reacting the at least one aromatic diamine mixture with at least one aromatic diacid dichloride, wherein hydrochloric acid and a polyamide solution is generated;

c) removing the free hydrochloric acid by reaction with a trapping reagent;

In one or more embodiments of the process for manufacturing a polyamide solution of this disclosure, the aromatic diacid dichloride includes those shown in the following general structures:

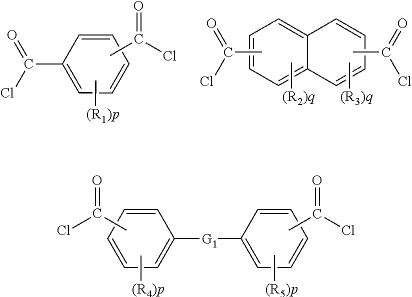

wherein p=4, q=3, and wherein R₁, R₂, R₃, R₄, R₅ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as a halogenated alkoxy, aryl, or substituted aryl such as halogenated aryls, alkyl ester and substituted alkyl esters, and combinations thereof. It is to be understood that each R₁ can be different, each R₂ can be different, each R₃ can be different, each R₄ can be different, and each R₅ can be different. G₁ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene.

In one or plurality of embodiments, in terms of using the film in a display element, an optical element, or an illumination element and suppressing Rth, examples of the aromatic diacid dichloride used in the process for manufacturing a solution of polyamide according to this disclosure include the following.

Terephthaloyl dichloride (TPC);

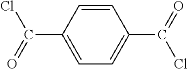 [SMILES: O=C(Cl)c1ccc(C(=O)Cl)cc1]

Isophthaloyl dichloride (IPC);

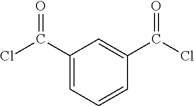 [SMILES: O=C(Cl)c1cccc(C(=O)Cl)c1]

2,6-Naphthaloyl dichloride (NDC);

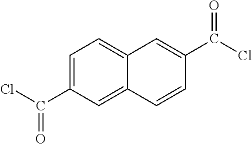 [SMILES: O=C(Cl)c1ccc2cc(C(=O)Cl)ccc2c1]

4,4′-Biphenyldicarbonyl dichloride (BPDC)

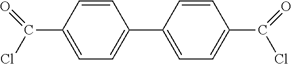 [SMILES: O=C(Cl)c1ccc(-c2ccc(C(=O)Cl)cc2)cc1]

In one or more embodiments of the process for manufacturing a polyamide solution of this disclosure, the aromatic diamine includes those shown in the following general structures:

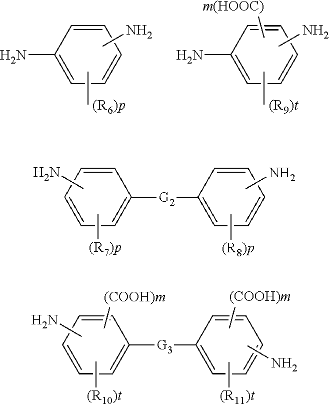

wherein p=4, m=1 or 2, and t=1 to 3, wherein R₆, R₇, R₈, R₉, R₁₀, R₁₁ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as a halogenated alkoxy, aryl, substituted aryl such as halogenated aryls, alkyl ester, and substituted alkyl esters, and combinations thereof. It is to be understood that each R₆ can be different, each R₇ can be different, each R₈ can be different, each R₉ can be different, each R₁₀ can be different, and each R₁₁ can be different. G₂ and G₃ are selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene.

In one or plurality of embodiments, in terms of using the film in a display element, an optical element, or an illumination element and suppressing Rth, examples of the aromatic diamine used in the process for manufacturing a solution of polyamide according this disclosure include the following.

4,4′-Diamino-2,2′-bistrifluoromethylbenzidine (PFMB)

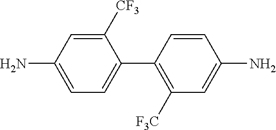 [SMILES: Nc1ccc(-c2ccc(N)cc2C(F)(F)F)c(C(F)(F)F)c1]

9,9-Bis(4-aminophenyl)fluorine (FDA)

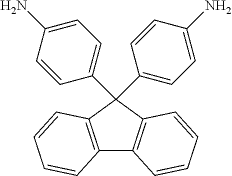 [SMILES: Nc1ccc(C2(c3ccc(N)cc3)c3ccccc3-c3ccccc32)cc1]

9,9-Bis(3-fluoro-4-aminophenyl)fluorine (FFDA)

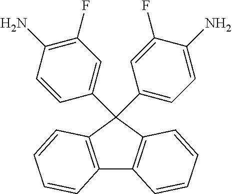 [SMILES: Nc1ccc(C2(c3ccc(N)c(F)c3)c3ccccc3-c3ccccc32)cc1F]

4,4′-Diaminodiphenic acid (DADP)

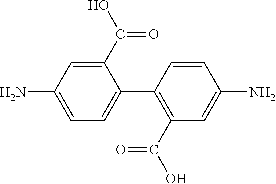 [SMILES: Nc1ccc(-c2ccc(N)cc2C(=O)O)c(C(=O)O)c1]

3,5-Diaminobenzoic acid (DAB)

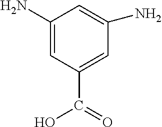 [SMILES: Nc1cc(N)cc(C(=O)O)c1]

4,4′-Diamino-2,2′-bistrifluoromethoxylbenzidine (PFMOB)

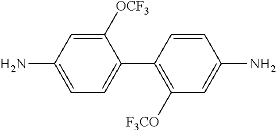 [SMILES: Nc1ccc(-c2ccc(N)cc2OC(F)(F)F)c(OC(F)(F)F)c1]

4,4′-Diamino-2,2′-bistrifluoromethyldiphenyl ether (6FODA)

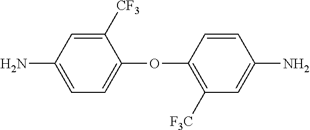 [SMILES: Nc1ccc(Oc2ccc(N)cc2C(F)(F)F)c(C(F)(F)F)c1]

Bis(4-amino-2-trifluoromethylphenyloxyl)benzene (6FOQDA)

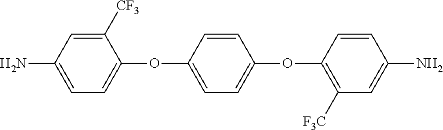 [SMILES: Nc1ccc(Oc2ccc(Oc3ccc(N)cc3C(F)(F)F)cc2)c(C(F)(F)F)c1]

Bis(4-amino-2-trifluoromethylphenyloxyl) biphenyl (6FOBDA)

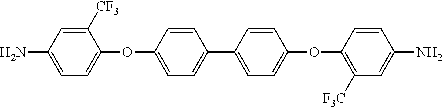 [SMILES: Nc1ccc(Oc2ccc(-c3ccc(Oc4ccc(N)cc4C(F)(F)F)cc3)cc2)c(C(F)(F)F)c1]

In one or more embodiments of the process for manufacturing a polyamide solution of this disclosure, a polyamide is prepared via a condensation polymerization in a solvent, where the hydrochloric acid generated in the reaction is trapped by a reagent like propylene oxide (PrO).

In one or plurality of embodiments of this disclosure, in terms of use of the polyamide solution in the process for manufacturing a display element, an optical element or an illumination element, the reaction of hydrochloric acid with the trapping reagent yields a volatile product.

In one or plurality of embodiments of this disclosure, in terms of use of the polyamide solution in the process for manufacturing a display element, an optical element or an illumination element, the trapping reagent is propylene oxide (PrO). In one or plurality of embodiments of this disclosure, the trapping reagent is added to the mixture before or during the reacting step (b). Adding the reagent before or during the reaction step (b) can reduce degree of viscosity and generation of lumps in the mixture after the reaction step (b), and therefore, can improve productivity of the solution of the polyamide. These effects are significant specifically when the reagent is organic reagent, such as propylene oxide.

In one or plurality of embodiments of this disclosure, in terms of enhancement of heat resistance property of the polyamide film, the process further comprises the step of end-capping of one or both of terminal —COOH group and terminal —NH₂ group of the polyamide. The terminal of the polyamide can be end-capped by the reaction of polymerized polyamide with benzoyl chloride when the terminal of Polyamide is —NH₂, or reaction of polymerized PA with aniline when the terminal of Polyamide is —COOH. However, the method of end-capping is not limited to this method.

In one or plurality of embodiments of this disclosure, in terms of use of the polyamide solution in the process for manufacturing a display element, an optical element or an illumination element, the polyamide is first isolated from the polyamide solution by precipitation and redissolved in a solvent. The precipitation can be carried out by a typical method. In one or plurality of embodiments, by adding the polyamide to methanol, ethanol, isopropyl alcohol or the like, it is precipitated, cleaned, and dissolved in the solvent, for example.

In one or plurality of embodiments of this disclosure, in terms of use of the polyamide solution in the process for manufacturing a display element, an optical element or an illumination element, the solution is produced in the absence of inorganic salt.

In one or plurality of embodiments, in terms of using the film in a display element, an optical element, or an illumination element and suppressing Rth, the aromatic polyamide of the solution of polyamide according to this disclosure has a flexible backbone. In one or plurality of embodiments, the term “the aromatic polyamide having a flexible backbone” as used herein means that an aromatic group in the polyamide main chain has repeat units that are bonded to a position other than the para-position, or refers to polyamide synthesized using aromatic monomer components having a flexible backbone.

[Average Molecular Weight of Polyamide]

In one or plurality of embodiments, in terms of using the film in a display element, an optical element, or an illumination element and suppressing Rth, it is preferable that the aromatic polyamide of the solution of polyamide according to this disclosure has a number-average molecular weight (Mn) of 6.0×10⁴ or more, 6.5×10⁴ or more, 7.0×10⁴ or more, 7.5×10⁴ or more, or 8.0×10⁴ or more. Similarly, in one or plurality of embodiments, the number-average molecular weight is 1.0×10⁶ or less, 8.0×10⁵ or less, 6.0×10⁵ or less, or 4.0×10⁵ or less.

In this disclosure, the number-average molecular weight (Mn) and the weight-average molecular weight (Mw) of the polyamide are measured by Gel Permeation Chromatography, and more specifically, they are measured by a method described in Examples.

In one or plurality of embodiments, in terms of using the film in a display element, an optical element, or an illumination element and suppressing Rth, it is preferable that the molecular weight distribution (=Mw/Mn) of the aromatic polyamide of the solution of polyamide according to this disclosure is 5.0 or less, 4.0 or less, 3.0 or less, 2.8 or less, 2.6 or less, or 2.4 or less. Similarly, in one or plurality of embodiments, the molecular weight distribution of the aromatic polyamide is 2.0 or more.

In one or plurality of embodiments, in terms of using the film in a display element, an optical element, or an illumination element, the solution of polyamide according to this disclosure is one undergone precipitation after the synthesis of the polyamide.

In one or plurality of embodiments of this disclosure, one or both of terminal —COOH group and terminal —NH₂ group of the aromatic polyamide are end-capped. The end-capping of the terminal is preferable from the point of enhancement of heat resistance property of the polyamide film. The terminal of the polyamide can be end-capped by the reaction of polymerized polyamide with benzoyl chloride when the terminal of Polyamide is —NH₂, or reaction of polymerized PA with aniline when the terminal of Polyamide is —COOH. However, the method of end-capping is not limited to this method.

In one or plurality of embodiments, in terms of using the film in a display element, an optical element, or an illumination element, monomers used for the synthesis of the polyamide of the solution of polyamide according to this disclosure may include a carboxyl group-containing diamine monomer. In that case, the carboxyl group-containing diamine monomer component accounts for, in one or plurality of embodiments, 30 mol % or less, 20 mol % or less, or 1 to 10 mol % of a total amount of monomers.

[Solvents]

In one or plurality of embodiments of this disclosure, in terms of enhancement of solubility of the polyamide in the solvent, the solvent is a polar solvent or a mixed solvent comprising one or more polar solvents. In one or plurality of embodiments, in terms of enhancement of solubility of the polyamide in the solvent, the polar solvent is methanol, ethanol, propanol, isopropanol (IPA), butanol, acetone, methyl ethyl ketone (MEK), methyl isobutyl ketone (MIBK), toluene, cresol, xylene, propylene glycol monomethyl ether acetate (PGMEA), N,N-dimethylacetamide (DMAc), or N-methyl-2-pyrrolidinone (NMP), dimethylsulfoxide (DMSO), butyl cellosolve, γ-butyrolactone, methyl cellosolve, ethyl cellosolve, ethylene glycol monobutyl ether, diethylene glycol monobutyl ether, N,N-dimethylformamide (DMF), 3-methoxy-N,N-dimethylpropionamide, 3-Butoxy-N,N-dimethylpropanamide, 1-Ethyl-2-pyrrolidone, N,N-Dimethylpropionamide, N,N-Dimethylbutyramide, N,N-Diethylacetamide, N,N-Diethylpropionamide, 1-Methyl-2-Piperidinone, Propylene carbonate, a combination thereof or a mixed solvent comprising at least one of the polar solvents.

[Polyamide Content]

In one or plurality of embodiments, in terms of using the film in a display element, an optical element, or an illumination element and suppressing Rth, the aromatic polyamide content of the solution of polyamide according to this disclosure is 2 wt % or more, 3 wt % or more, or 5 wt % or more. Similarly, the aromatic polyamide content is 30 wt % or less, 20 wt % or less, or 15 wt % or less.

In one or plurality of embodiments, the solution of polyamide according to this disclosure is a solution of polyamide for use in a process for manufacturing a display element, an optical element, or an illumination element, including the steps a) to c).

a) applying a solution of an aromatic copolyamide onto a base;

b) forming a polyamide film on the base after the applying step (a); and

c) forming the display element, the optical element or the illumination element on the surface of polyamide film,

wherein the base or the surface of the base is composed of glass or silicon wafer.

[Laminated Composite Material]

The term “laminated composite material” as used herein refers to a material in which a glass plate and a polyamide resin layer are laminated. In one or plurality of non-limiting embodiments, a glass plate and a polyamide resin layer being laminated means that the glass plate and the polyamide resin layer are laminated directly. Alternatively, in one or plurality of non-limiting embodiments, it means that the glass plate and the polyamide resin layer are laminated through one or more layers. Herein, the organic resin of the organic resin layer is a polyamide resin. Thus, in one or plurality of embodiments, the laminated composite material of this disclosure includes a glass plate and a polyamide resin layer, and the polyamide resin is laminated on one surface of the glass plate.

In one or plurality of non-limiting embodiments, the laminated composite material according to this disclosure can be used in a process for manufacturing a display element, an optical element, or an illumination element, such as the one described in FIG. 2. Further, in one or plurality of none-limiting embodiments, the laminated composite material according to this disclosure can be used as a laminated composite material obtained in the step B of the manufacturing process described in FIG. 2. Therefore, in one or plurality of none-limiting embodiments, the laminated composite material according to this disclosure is a laminated composite material for use in a process for manufacturing a display element, an optical element, or an illumination element, including the step of forming the display element, the optical element, or the illumination element on a surface of the polyamide resin layer, wherein the surface is not opposed to a glass plate.

The laminated composite material according to this disclosure may include additional organic resin layers and/or inorganic layers in addition to the polyamide resin layer. In one or plurality of none-limiting embodiments, examples of additional organic resin layers include a flattening coat layer.

Further, in one or plurality of none-limiting embodiments, examples of inorganic layers include a gas barrier layer capable of suppressing permeation of water, oxygen, or the like and a buffer coat layer capable of suppressing migration of ions to a TFT element.

[Polyamide Resin Layer]

The polyamide resin of the polyamide resin layer of the laminated composite material according to this disclosure may be formed using the solution of polyamide according to this disclosure.

In one or plurality of embodiments, in terms of suppressing Rth, elastic modulus at 30° C. of the polyamide resin layer is 5.0 GPa or less, 4.5 GPa or less, 4.0 GPa or less, 3.5 GPa or less, 3.2 GPa or less, 3.0 GPa or less, less than 3.0 GPa, or 2.8 GPa or less. Further, in one or plurality of embodiments, in terms of using the polyamide resin layer in a display element, an optical element, or an illumination element, the elastic modulus at 30° C. is 0.1 GPa or more or 0.5 GPa or more. The modulus at 30° C. can be measured in the same manner as the one described above.

In one or plurality of embodiments, in terms of suppressing Rth, CTE of the polyamide resin layer is more than 30.0 ppm/K, 32.0 ppm/K or more, 34.0 ppm/K or more, 36.0 ppm/K or more, 38.0 ppm/K or more, or 40.0 ppm/K or more. Further, in one or plurality of embodiments, in terms of using the polyamide resin layer in a display element, an optical element, or an illumination element, the CTE is 60.0 ppm/K or less. CTE can be measured in the same manner as the one described above.

In one or plurality of embodiments, in terms of using the film in a display element, an optical element or an illumination element, the polyamide resin has a glass transition temperature of 250 to 550° C. Note that the glass transition temperature of the polyamide film is measured through dynamic mechanical analysis, and more specifically, it is measured by a method described in Examples.

[Thickness of Polyamide Resin Layer]

In one or plurality of embodiments, in terms of using the film in a display element, an optical element, or an illumination element and suppressing the development of cracks in the resin layer, the polyamide resin layer of the laminated composite material according to this disclosure has a thickness of 500 μm or less, 200 μm or less, or 100 μm or less. Further, in one or plurality of none-limiting embodiments, the polyamide resin layer has a thickness of 1 μm or more, 2 μm or more, or 3 μm or more, for example.

[Transmittance of Polyamide Resin Layer]

In one or plurality of embodiments, the polyamide resin layer of the laminated composite material according to this disclosure has a total light transmittance at 550 nm of 70% or more, 75% or more, or 80% or more in terms of allowing the laminated composite material to be used suitably in the production of a display element, an optical element, or an illumination element.

[Glass Plate]

In one or plurality of embodiments, in terms of using the film in a display element, an optical element, or an illumination element, the material of the glass plate of the laminated composite material according to this disclosure may be, for example, soda-lime glass, none-alkali glass or the like.

In one or plurality of embodiments, in terms of using the film in a display element, an optical element, or an illumination element, the glass plate of the laminated composite material according this disclosure has a thickness of 0.3 mm or more, 0.4 mm or more, or 0.5 mm or more. Further, in one or plurality of embodiments, the glass plate has a thickness of 3 mm or less or 1 mm or less, for example.

[Process for Manufacturing Laminated Composite Material]

The laminated composite material according to this disclosure can be manufactured by applying the solution of polyamide according to this disclosure onto a glass plate, and drying, and if necessary curing, the applied solution.

In one or plurality of embodiments of this disclosure, a process for manufacturing the laminated composite material of this disclosure includes the steps of:

a) applying a solution of an aromatic polyamide onto a base (glass plate); and

b) heating the casted polyamide solution to form a polyamide film after the applying step (a).

In one or plurality of embodiments of this disclosure, in terms of suppression of curvature deformation (warping) and/or enhancement of dimension stability, the heating is carried out under the temperature ranging from approximately +40° C. of the boiling point of the solvent to approximately +100° C. of the boiling point of the solvent, preferably from approximately +60° C. of the boiling point of the solvent to approximately +80° C. of the boiling point of the solvent, more preferably approximately +70° C. of the boiling point of the solvent. In one or plurality of embodiments of this disclosure, in terms of suppression of curvature deformation (warping) and/or enhancement of dimension stability, the temperature of the heating in step (b) is between approximately 200° C. and approximately 250° C. In one or plurality of embodiments of this disclosure, in terms of suppression of curvature deformation (warping) and/or enhancement of dimension stability, the time of the heating is more than approximately 1 minute and less than approximately 30 minutes.

The process for manufacturing the laminated composite material may include, following the step (b), a curing step (c) in which the polyamide film is cured. The curing temperature depends upon the capability of a heating device but is 220 to 420° C., 280 to 400° C., 330° C. to 370° C., 340° C. or more or 340 to 370° C. in one or plurality of embodiments. Further, in one or plurality of embodiments, the curing time is 5 to 300 minutes or 30 to 240 minutes.

[Process for Manufacturing Display Element, Optical Element or Illumination Element]

This disclosure, in one aspect, relates to a process for manufacturing a display element, an optical element, or an illumination element, which includes the step of forming the display element, the optical element, or the illumination element on a surface of the organic resin layer of the laminated composite material according to this disclosure, wherein the surface is not opposed to the glass plate. In one or plurality of embodiments, the manufacturing process further includes the step of de-bonding the display element, the optical element, or the illumination element formed from the glass plate.

[Display Element, Optical Element, or Illumination Element]

The term “a display element, an optical element, or an illumination element” as used herein refers to an element that constitutes a display (display device), an optical device, or an illumination device, and examples of such elements include an organic EL element, a liquid crystal element, and organic EL illumination. Further, the term also covers a component of such elements, such as a thin film transistor (TFT) element, a color filter element or the like. In one or more embodiments, the display element, the optical element or the illumination element according to the present disclosure may include the polyamide film according to the present disclosure, which may be produced using the solution of polyamide according to the present disclosure, or may use the polyamide film according to the present disclosure as the substrate for the display element, the optical element or the illumination element.

### Non-Limiting Embodiment of Organic EL Element

Hereinafter, one embodiment of an organic EL element as one embodiment of the display element according to the present disclosure will be described with reference to the drawing.

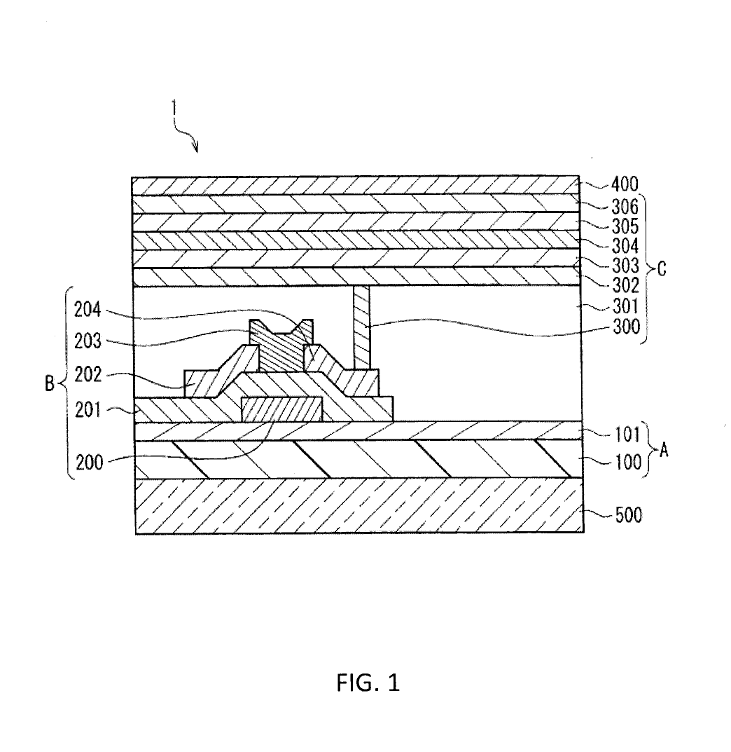

FIG. 1 is a schematic cross-sectional view showing an organic EL element 1 according to one embodiment. The organic EL element 1 includes a thin film transistor B formed on a substrate A and an organic EL layer C. Note that the organic EL element 1 is entirely covered with a sealing member 400. The organic EL element 1 may be separate from a base 500 or may include the base 500. Hereinafter, each component will be described in detail.

1. Substrate A

The substrate A includes a transparent resin substrate 100 and a gas barrier layer 101 formed on top of the transparent resin substrate 100. Here, the transparent resin substrate 100 is the polymer film according to the present disclosure.

The transparent resin substrate 100 may have been annealed by heat. Annealing is effective in, for example, removing distortions and in improving the size stability against environmental changes.

The gas barrier layer 101 is a thin film made of SiOx, SiNx or the like, and is formed by a vacuum deposition method such as sputtering, CVD, vacuum deposition or the like. Generally, the gas barrier layer 101 has a thickness of, but is not limited to, about 10 nm to 100 nm. Here, the gas barrier layer 101 may be formed on the side of the transparent resin substrate 100 facing the gas barrier layer 101 in FIG. 1 or may be formed on the both sides of the transparent resin substrate 100.

2. Thin Film Transistor

The thin film transistor B includes a gate electrode 200, a gate insulating layer 201, a source electrode 202, an active layer 203, and a drain electrode 204. The thin film transistor B is formed on the gas barrier layer 101.

The gate electrode 200, the source electrode 202, and the drain electrode 204 are transparent thin films made of indium tin oxide (ITO), indium zinc oxide (IZO), zinc oxide (ZnO), or the like. For example, sputtering, vapor deposition, ion platting or the like may be use to form these transparent thin films. Generally, these electrodes have a film thickness of, but is not limited to, about 50 nm to 200 nm.

The gate insulating film 201 is a transparent insulating thin film made of SiO₂, Al₂O₃ or the like, and is formed by sputtering, CVD, vacuum deposition, ion plating or the like. Generally, the gate insulating film 201 has a film thickness of, but is not limited to, about 10 nm to 1 μm.

The active layer 203 is a layer of, for example, single crystal silicon, low temperature polysilicon, amorphous silicon, or oxide semiconductor, and a material best suited to the active layer 203 is used as appropriate. The active layer is formed by sputtering or the like.

3. Organic EL Layer

The organic EL layer C includes a conductive connector 300, an insulative flattened layer 301, a lower electrode 302 as the anode of the organic EL element 1, a hole transport layer 303, a light-emitting layer 304, an electron transport layer 305, and an upper electrode 306 as the cathode of the organic EL element 1. The organic EL layer C is formed at least on the gas barrier layer 101 or on the thin film transistor B, and the lower electrode 302 and the drain electrode 204 of the thin film transistor B are connected to each other electrically through the connector 300. Instead, the lower electrode 302 of the thin film transistor B and the source electrode 202 may be connected to each other through the connector 300.

The lower electrode 302 is the anode of the organic EL element 1, and is a transparent thin film made of indium tin oxide (ITO), indium zinc oxide (IZO), zinc oxide (ZnO) or the like. ITO is preferred because, for example, high transparency, and high conductivity can be achieved.

For the hole transport layer 303, the light-emitting layer 304, and the electron transport layer 305, conventionally-known materials for organic EL elements can be used as is.

The upper electrode 305 is a film composed of a layer of lithium fluoride (LiF) having a film thickness of 5 nm to 20 nm and a layer of aluminum (Al) having a film thickness of 50 nm to 200 nm. For example, vapor deposition may be use to form the film.

When producing a bottom emission type organic EL element, the upper electrode 306 of the organic EL element 1 may be configured to have optical reflectivity. Thereby, the upper electrode 306 can reflect in the display side direction light generated by the organic EL element 1 and traveled toward the upper side as the opposite direction to the display side. Since the reflected light is also utilized for a display purpose, the emission efficiency of the organic EL element can be improved.

[Method of Producing Display Element, Optical Element, or Illumination Element]

Another aspect of the present disclosure relates to a method of producing a display element, an optical element, or an illumination element. In one or more embodiments, the production method according to the present disclosure is a method of producing the display element, the optical element, or the illumination element according to the present disclosure. Further, in one or more embodiments, the production method according to the present disclosure is a method of producing a display element, an optical element, or an illumination element, which includes the steps of applying the polyamide resin solution according to the present disclosure onto a base; forming a polyamide film after the application step; and forming the display element, the optical element, or the illumination element on the side of the base not in contact with the polyamide resin film. The production method according to the present disclosure may further include the step of de-bonding, from the base, the display element, the optical element, or the illumination element formed on the base.

### Non-Limiting Embodiment of Method of Producing Organic EL Element

As one embodiment of the method of producing a display element according to the present disclosure, hereinafter, one embodiment of a method of producing an organic EL element will be described with reference to the drawing.

A method of producing the organic EL element 1 shown in FIG. 1 includes a fixing step, a gas barrier layer preparation step, a thin film transistor preparation step, an organic EL layer preparation step, a sealing step and a de-bonding step. Hereinafter, each step will be described in detail.

1. Fixing Step

In the fixing step, the transparent resin substrate 100 is fixed onto the base 500. A way to fix the transparent resin substrate 100 to the base 500 is not particularly limited. For example, an adhesive may be applied between the base 500 and the transparent substrate or a part of the transparent resin substrate 100 may be fused and attached to the base 500 to fix the transparent resin substrate 100 to the base 500. Further, as the material of the base, glass, metal, silicon, resin or the like is used, for example. These materials may be used alone or in combination of two or more as appropriate. Furthermore, the transparent resin substrate 100 may be attached to the base 500 by applying a releasing agent or the like to the base 500 and placing the transparent resin substrate 100 on the applied releasing agent. In one or more embodiments, the polyamide film 100 is formed by applying the polyamide resin composition according to the present disclosure to the base 500, and drying the applied polyamide resin composition.

2. Gas Barrier Layer Preparation Step

In the gas barrier layer preparation step, the gas barrier layer 101 is prepared on the transparent resin substrate 100. Away to prepare the gas barrier layer 101 is not particularly limited, and a known method can be used.

3. Thin Film Transistor Preparation Step

In the thin film transistor preparation step, the thin film transistor B is prepared on the gas barrier layer. Away to prepare the thin film transistor B is not particularly limited, and a known method can be used.

4. Organic EL Layer Preparation Step

The organic EL layer preparation step includes a first step and a second step. In the first step, the flattened layer 301 is formed. The flattened layer 301 can be formed by, for example, spin-coating, slit-coating, or ink-jetting a photosensitive transparent resin. At that time, an opening needs to be formed in the flattened layer 301 so that the connector 300 can be formed in the second step. Generally, the flattened layer has a film thickness of, but is not limited to, about 100 nm to 2 μm.

In the second step, first, the connector 300 and the lower electrode 302 are formed at the same time. Sputtering, vapor deposition, ion platting or the like may be used to form the connector 300 and the lower electrode 302. Generally, these electrodes have a film thickness of, but is not limited to, about 50 nm to 200 nm. Subsequently, the hole transport layer 303, the light-emitting layer 304, the electron transport layer 305, and the upper electrode 306 as the cathode of the organic EL element 1 are formed. To form these components, a method such as vapor deposition, application, or the like can be used as appropriate in accordance with the materials to be used and the laminate structure. Further, irrespective of the explanations given in this example, other layers may be chosen from known organic layers such as a hole injection layer, an electron transport layer, a hole blocking layer and an electron blocking layer as needed and be used to configuring the organic layers of the organic EL element 1.

5. Sealing Step

In the sealing step, the organic EL layer C is sealed with the sealing member 307 from top of the upper electrode 306. For example, a glass material, a resin material, a ceramics material, a metal material, a metal compound or a composite thereof can be used to form the sealing member 307, and a material best suited to the sealing member 307 can be chosen as appropriate.

6. De-Bonding Step

In the de-bonding step, the organic EL element 1 prepared is stripped from the base 500. To implement the de-bonding step, for example, the organic EL element 1 may be physically stripped from the base 500. At that time, the base 500 may be provided with a de-bonding layer, or a wire may be inserted between the base 500 and the display element to remove the organic EL element. Further, examples of other methods of de-bonding the organic EL element 1 from the base 500 include the following: forming a de-bonding layer on the base 500 except at ends, and cutting, after the preparation of the element, the inner part from the ends to remove the element from the base; providing a layer of silicon or the like between the base 500 and the element, and irradiating the silicon layer with a laser to strip the element; applying heat to the base 500 to separate the base 500 and the transparent substrate from each other; and removing the base 500 using a solvent. These methods may be used alone or any of these methods may be used in combination of two or more. In one or more embodiments, the strength of adhesion between PA film and the Base can be controlled by silane coupling agent, so that the organic EL element 1 may be physically stripped without using the above-described complicated processes.

In one or more embodiments, the organic EL element obtained by the method of producing a display, optical or illumination element according to the present embodiment has excellent characteristics such as excellent transparency and heat-resistance, low linear expansivity and low optical anisotropy.

[Display Device, Optical Device, and Illumination Device]

Another aspect of the present disclosure relates to a display device, an optical device, or an illumination device using the display element, the optical element, or the illumination element according to the present disclosure, or a method of producing the display device, the optical device, or the illumination device. Examples of the display device include, but are not limited to, an imaging element, examples of the optical device include, but are not limited to, a photoelectric complex circuit, and examples of the illumination device include, but are not limited to, a TFT-CD and OEL illumination devices.

This disclosure may relate to one or plurality of the following embodiments.

<1> A solution of polyamide comprising: an aromatic polyamide; and a solvent; wherein the aromatic polyamide comprises at least two repeat units, and at least one of the repeat units has one or more free carboxyl groups, and wherein elastic modulus at 30° C. of a cast film formed by applying the solution onto a glass plate is 5.0 GPa or less, and coefficient of thermal expansion (CTE) of the cast film is more than 30.0 ppm/K.

<2> The solution according to <1>, wherein the elastic modulus at 30° C. is 3.5 GPa or less.

<3> The solution according to <1> or <2>, wherein retardation (Rth) at 400 nm of thickness direction of a cast film formed by applying the solution onto a glass plate is 350.0 nm or less.

<4> The solution according to any one of <1> to <3>, wherein retardation (Rth) at 400 nm of thickness direction of a cast film formed by applying the solution onto a glass plate is 200.0 nm or less.

<5> The solution according to any one of <1> to <4>, wherein a ratio of the amount of aromatic monomer components that have a flexible backbone to the total amount of monomer components used for synthesis of the polyamide is 40 mol % or more.

<6> The solution according to any one of <1> to <5>, wherein the polyamide comprising:
an aromatic polyamide having repeat units of general formulas (I) and (II):

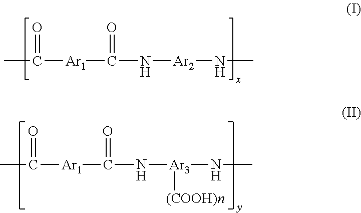

wherein x represents mole % of the repeat structure (I), y represents mole % of the repeat structure (II), x varies from 70 to 99.99, and y varies from 30 to 0.01;
wherein n=1 to 4;
wherein Ar₁ is selected from the group comprising:

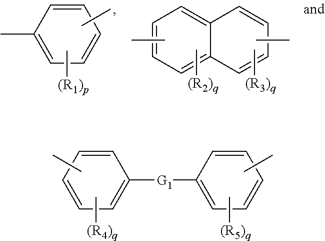

wherein p=4, q=3, and wherein R₁, R₂, R₃, R₄, R₅ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, or substituted aryl such as halogenated aryls, alkyl ester and substituted alkyl esters, and combinations thereof, wherein G₁ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene;
wherein Ar₂ is selected from the group of comprising:

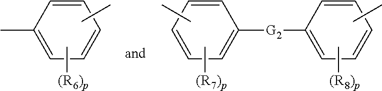

wherein p=4, wherein R₆, R₇, R₈ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, substituted aryl such as halogenated aryls, alkyl ester, and substituted alkyl esters, and combinations thereof, wherein G₂ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene;
wherein Ar₃ is selected from the group comprising:

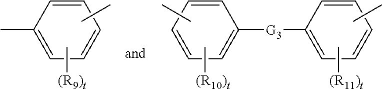

wherein t=1 to 3, wherein R₉, R₁₀, R₁₁ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, substituted aryl such as halogenated aryls, alkyl ester, and substituted alkyl esters, and combinations thereof, wherein G₃ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene.

<7> The solution according to <6>, wherein the polyamide contains multiple repeat units of the general formulas (I) and (II), and wherein Ar₁, Ar₂, and Ar₃ are the same or different.

<8> The solution according to any one of <1> to <7>, wherein the polyamide is obtained by polymerizing aromatic diacid dichlorides as shown in the following general structures:

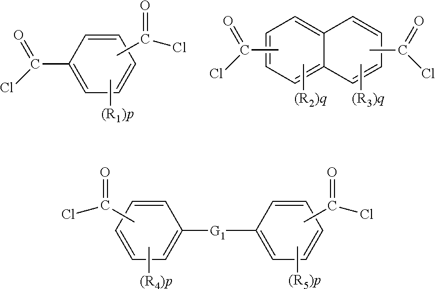

wherein p=4, q=3, and wherein R₁, R₂, R₃, R₄, R₅ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as a halogenated alkoxy, aryl, or substituted aryl such as halogenated aryls, alkyl ester and substituted alkyl esters, and combinations thereof. It is to be understood that each R₁ can be different, each R₂ can be different, each R₃ can be different, each R₄ can be different, and each R₅ can be different. G₁ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene.

<9> The solution according to any one of <1> to <8>, wherein the polyamide is obtained by polymerizing aromatic diamines as shown in the following general structures:

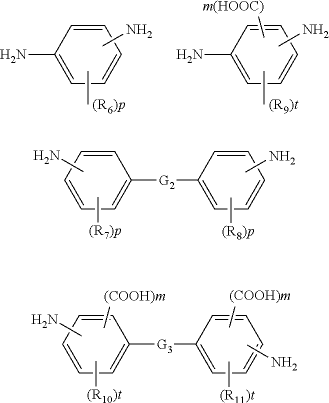

wherein p=4, m=1 or 2, and t=1 to 3, wherein R₆, R₇, R₈, R₉, R₁₀, R₁₁ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as a halogenated alkoxy, aryl, substituted aryl such as halogenated aryls, alkyl ester, and substituted alkyl esters, and combinations thereof. It is to be understood that each R₆ can be different, each R₇ can be different, each R₈ can be different, each R₉ can be different, each R₁₀ can be different, and each R₁₁ can be different. G₂ and G₃ are selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene.

<10> The solution according to any one of <1> to <9>, wherein at least one of terminals of the polyamide is end-capped.

<11> The solution according to any one of <1> to <10>, for use in the process for manufacturing a display element, an optical element or an illumination element, comprising the steps of:
a) applying a solution of an aromatic copolyamide onto a base;
b) forming a polyamide film on the base after the applying step (a); and
c) forming the display element, the optical element or the illumination element on the surface of polyamide film,
wherein the base or the surface of the base is composed of glass or silicon wafer.

<12> A laminated composite material, comprising a glass plate, and a polyamide resin layer;
wherein the polyamide resin layer is laminated on one surface of the glass plate;
wherein elastic modulus at 30° C. of the polyamide resin layer is 5.0 GPa or less, and coefficient of thermal expansion (CTE) of the cast film is more than 30.0 ppm/K; and
wherein the polyamide resin layer is obtained by applying the solution of polyamide according to any one of <1> to <11> on the glass plate.

<13> The laminated composite material according to <12>, wherein the elastic modulus at 30° C. is 3.5 GPa or less.

<14> The laminated composite material according to <12> or <13>, wherein retardation (Rth) at 400 nm of thickness direction of the polyamide resin layer is 350.0 nm or less.

<15> The laminated composite material according to any one of <12> to <14>, wherein retardation (Rth) at 400 nm of thickness direction of the polyamide resin layer is 200.0 nm or less.

<16> The laminated composite material according to any one of <12> to <15>, wherein the thickness of the glass plate is 0.3 mm or more.

<17> The laminated composite material according to any one of <12> to <16>, wherein the thickness of the polyamide resin is 500 μm or less.

<18> The laminated composite material according to any one of <12> to <17>, wherein the total light transmittance at 550 nm of the polyamide resin is 70% or more.

<19> A process for manufacturing a display element, an optical element or an illumination element, comprising the step of:
forming the display element, the optical element or the illumination element on a surface of the polyamide resin layer of the laminated composite material according to any one of <12> to <18>, wherein the surface is not opposed to the glass plate.

<20> The process according to <19>, further comprising the step of:

de-bonding, from the glass plate, the display element, the optical element or the illumination element formed on the base.

<21> A display element, an optical element or an illumination element manufactured using the solution of polyamide according to any one of <1> to <11> or the laminated composite material according to any one of <12> to <18>, comprising the polyamide resin of the laminated composite material.

### EXAMPLES

### Preparation of Solutions of Polyamide

Polyamide solutions (Solutions 1 to 30) were prepared using components as described in Table 1 as well as bellow. The number-average molecular weight (Mn) and the weight-average molecular weight (Mw) of each polyamide prepared, and the glass transition temperature (Tg), elastic modulus, coefficient of thermal expansion (CTE), and retardation (Rth) in thickness direction at 400 nm of films formed using the polyamide solutions were determined in the following manners.

[Aromatic Diamine]

PFMB: 4,4′-Diamino-2,2′-bistrifluoromethylbenzidine;

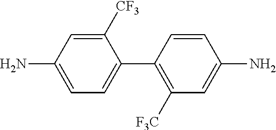 [SMILES: Nc1ccc(-c2ccc(N)cc2C(F)(F)F)c(C(F)(F)F)c1]

DAB: 4,4′-diaminobenzoic acid;

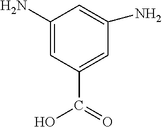 [SMILES: Nc1cc(N)cc(C(=O)O)c1]

FDA: 9,9-Bis(4-aminophenyl)fluorine;

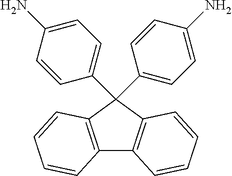 [SMILES: Nc1ccc(C2(c3ccc(N)cc3)c3ccccc3-c3ccccc32)cc1]

FFDA: 9,9-Bis(3-fluoro-4-aminophenyl)fluorine;

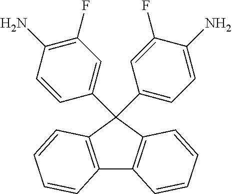 [SMILES: Nc1ccc(C2(c3ccc(N)c(F)c3)c3ccccc3-c3ccccc32)cc1F]

[Solvent]

DMAc: N,N-dimethylacetamide

[Aromatic Diacid Dichloride]

TPC: Terephthaloyl dichloride;

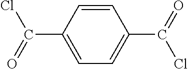 [SMILES: O=C(Cl)c1ccc(C(=O)Cl)cc1]

IPC: Isophthaloyl dichloride;

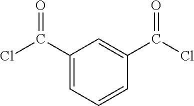 [SMILES: O=C(Cl)c1cccc(C(=O)Cl)c1]

[Trapping Reagent]

PrO: propylene oxide

[Number-Average Molecular Weight (Mn) and Weight-Average Molecular Weight (Mw)]

The number-average molecular weight (Mn) and the weight-average molecular weight (Mw) of each synthesized polyamide were measured using the following device and mobile phase.

Device: Gel Permeation Chromatography (HLC-8320 GPC from Tosoh Corporation)
Mobile Phase: DMAc, lithium bromide 10 mM, phosphoric acid 5 mM

[Elastic Modulus (E′), Glass Transition Temperature (Tg)]

For E′ and Tg of each polyamide film, the dynamic viscoelasticity in a range of 25° C. to 400° C. was measured using a dynamic mechanical analyzer (RHEOVIBRON DDV-01FP from A&D Company Ltd.) in air at a programming rate of 5° C./min and a tension of 10 mN to obtain E′ at 30° C., and the maximum value of tan D in the measurement was set as Tg.

[Coefficient of Thermal Expansion (CTE)]

As the coefficient of thermal expansion (CTE) of each polyamide film, an average coefficient of thermal expansion determined in the following manner was adopted.

First, the temperature of each sample was increased from 30° C. to 300° C. at 10° C./min in a nitrogen atmosphere using TMA4000SA from Bruker AXS, followed by maintaining the temperature at 300° C. for 30 minutes, and then cooled to 25° C. at 10° C./min, and the average coefficient of thermal expansion of each sample undergone the process was measured. The width of each sample was 5 mm, and the load was 2 g. The measurement was carried out in the tensile mode. The average coefficient of thermal expansion was determined using the following formula.

Average Coefficient of Thermal Expansion (ppm/K)=((L₃₀₀−L₃₀)L₃₀)/(300−30)×10⁶

L₃₀₀: the sample length at 300° C.
L₃₀: the sample length at 30° C.

[Retardation in Thickness Direction (Rth)]

Retardation in thickness direction of each polyamide film at 400 nm was calculated as follows. With a retardation measuring device (KOBRA-21 ADH from Oji Scientific Instruments), the retardation between 0° and 40° was measured using the wavelength dispersion measurement mode (light at 479.2 nm, 545.4 nm, 630.3 nm, and 748.9 nm), and the retardation between 0° and 40° at 400 nm was calculated using the Sellmeier equation, and from the value and refractive index obtained, Rth at an arbitrary wavelength (400 nm in this case) was calculated.

[Total Light Transmittance at 500 nm]

The total light transmittance of each polyamide film at 550 nm was measured using a spectrophotometer (N-670 from JASCO Corporation).

This example illustrates the general procedure for the preparation of Solution 1 containing 5 weight % of a copolymer of IPC, DAB, and PFMB (100%/5%/95% mol ratio) in DMAc.

To a 250 ml three necked round bottom flask, equipped with a mechanical stirrer, a nitrogen inlet and outlet, are added PFMB (3.042 g, 0.0095 mol), DAB (0.0761 g, 0.0005 mol) and DMAc (45 ml). After the PFMB and DAB dissolved completely, PrO (1.4 g, 0.024 mol) was added to the solution. The solution is cooled to 0° C. Under stirring, IPC (2.01 g, 0.0099 mol) was added to the solution, and the flask wall was washed with DMAc (1.5 nil). After two hours, benzoyl chloride (0.032 g, 0.23 mmol) was added to the solution and stirred for another two hours.

As with Solution 1, Solutions 2 to 30 were prepared as 5 wt % polyamide solutions.

[Formation of Polyamide Films]

Solutions 1 to 30 as the polyamide solutions prepared were casted onto a glass base to form films, and the properties of each film were studied.

Each polyamide solution was applied onto a flat glass base (10 cm×10 cm, trade name: EAGLE XG from Corning Inc., USA) by spin coating. After drying the casted solution for 30 minutes or more at 60° C., the temperature was increased from 60° C. to 330° C. or 350° C., and the temperature was maintained at 330° C. or 350° C. for 30 minutes under vacuum or in an inert atmosphere to cure the film. The polyamide films obtained had a thickness of about 10 μm.

The properties of the polyamide films (Tg, elastic modulus, CTE, and Rth) were measured in the above-described manners. Table 1 provides the results.

TABLE 1
Table 1

| | | | | | | | | | | Ratio of | | | | |
|---|---|---|---|---|---|---|---|---|---|---|---|---|---|---|
| | | | | | | | | | | flexible | Film Property | | | |
| | Avergae molecular | | | Composition | | | | | | component | | | CTE | Rth |
| | weight | | Cure | Diacid | | | | | | (mol %) | | E′ | (ppm/ | @400 |
| | | Mw × | temp. | dichloride | | Diamine | | | | IPC + FDA + DAB/ | Tg | (Gpa) | K) | nm |
| | Mn × 10\hat{ }4 | 10\hat{ }4 | (° C.) | TPC | IPC | FDA | F-FDA | PFMB | DAB | T + I + F + P + D | (° C.) | 30° C. | 30-300 | (nm) |
| Solution 01 | 21.4 | 86.5 | 330 | 0 | 100 | 0 | 0 | 95 | 5 | 52.5 | 344.4 | 2.6 | 53.8 | 113.4 |
| Solution 02 | 18.5 | 114.1 | 330 | 0 | 100 | 15 | 0 | 80 | 5 | 60.0 | 350.5 | 2.7 | 51.5 | 171.9 |
| Solution 03 | 11.3 | 68.4 | 330 | 0 | 100 | 45 | 0 | 50 | 5 | 75.0 | 361.0 | 2.5 | 46.9 | 169.0 |
| Solution 04 | 31.4 | 88.2 | 330 | 0 | 100 | 75 | 0 | 20 | 5 | 90.0 | 373.4 | 2.5 | 42.3 | 124.1 |
| Solution 05 | 5.3 | 20.3 | 330 | 100 | 0 | 15 | 0 | 80 | 5 | 10.0 | 384.0 | 6.4 | 7.09 | 1014.4 |
| Solution 06 | 7.7 | 29.9 | 330 | 100 | 0 | 45 | 0 | 50 | 5 | 25.0 | >400 | 5.7 | 19.7 | 768.3 |
| Solution 07 | 6.2 | 24.6 | 330 | 100 | 0 | 75 | 0 | 20 | 5 | 40.0 | >400 | 4.4 | 33.7 | 252.7 |
| Solution 08 | 6.1 | 24.6 | 330 | 100 | 0 | 85 | 0 | 10 | 5 | 45.0 | — | 4.0 | 36.4 | 230.0 |
| Solution 09 | 5.4 | 14.4 | 330 | 100 | 0 | 0 | 95 | 0 | 5 | 50.0 | >400 | 3.0 | 50.5 | 154.2 |
| Solution 10 | 10.4-11.1 | 32.1-34.0 | 350 | 70 | 30 | 0 | 0 | 95 | 5 | 17.5 | 379.8 | 3.3 | 26.9 | 491.2 |
| Solution 11 | 8.6 | 29.0 | 330 | 70 | 30 | 0 | 0 | 95 | 5 | 17.5 | 359.8 | 5.2 | 18.7 | 889.0 |
| Solution 12 | 9.1 | 25.7 | 330 | 70 | 30 | 0 | 0 | 95 | 5 | 17.5 | 360.8 | 5.1 | 18.2 | 795.3 |
| Solution 13 | 10.3 | 33.2 | 330 | 70 | 30 | 0 | 0 | 95 | 5 | 17.5 | 360.2 | 2.7 | 11.5 | 1084.6 |
| Solution 14 | 10.8 | 34.3 | 330 | 70 | 30 | 0 | 0 | 95 | 5 | 17.5 | 358.8 | 5.5 | 11.5 | 1014.0 |
| Solution 15 | 13.8 | 38.7 | 330 | 40 | 60 | 0 | 0 | 95 | 5 | 32.5 | 352.7 | 3.7 | 26 | 589.5 |
| Solution 16 | 19.8 | 51.9 | 330 | 40 | 60 | 0 | 0 | 95 | 5 | 32.5 | 357.4 | 3.4 | 30 | 475.3 |
| Solution 17 | 13.0-14.7 | 39.2-48.1 | 330 | 45 | 55 | 0 | 0 | 95 | 5 | 30.0 | 355.4 | 4.2 | 27.3 | 557.8 |
| Solution 18 | 16.5-17.1 | 48.8-52.8 | 330 | 10 | 90 | 0 | 0 | 95 | 5 | 47.5 | 344.0 | 2.6 | 49.4 | 173.0 |
| Solution 19 | 14.4-15.5 | 44.8-48.7 | 330 | 0 | 100 | 0 | 0 | 95 | 5 | 52.5 | 343.0 | 2.3 | 52.8 | 108.5 |
| Solution 20 | | | 350 | 90 | 10 | 70 | 0 | 25 | 5 | 42.5 | 408 | 4.6 | 33.9 | 307 |
| Solution 21 | | | 350 | 70 | 30 | 65 | 0 | 30 | 5 | 50.0 | 391 | 4.4 | 35.3 | 299 |
| Solution 22 | | | 350 | 50 | 50 | 50 | 0 | 45 | 5 | 52.5 | 375 | 4.6 | 42.1 | 253 |
| Solution 23 | | | 350 | 30 | 70 | 20 | 0 | 75 | 5 | 47.5 | 366 | 3.9 | 53.3 | 54 |
| Solution 24 | | | 350 | 70 | 30 | 45 | 0 | 50 | 5 | 40.0 | 384 | 4.0 | 38.3 | 305 |
| Solution 25 | | | 350 | 50 | 50 | 25 | 0 | 70 | 5 | 40.0 | 373 | 4.1 | 47.8 | 126 |
| Solution 26 | | | 350 | 30 | 70 | 95 | 0 | 0 | 5 | 85.0 | 381 | 3.1 | 48 | 64 |
| Solution 27 | | | 350 | 40 | 60 | 95 | 0 | 0 | 5 | 80.0 | 390 | 3.8 | 45 | 73 |
| Solution 28 | | | 350 | 50 | 50 | 50 | 0 | 45 | 5 | 52.5 | 382 | 3.8 | 36.6 | 205 |
| Solution 29 | | | 350 | 40 | 60 | 60 | 0 | 35 | 5 | 62.5 | 380 | 4.0 | 44.4 | 141 |
| Solution 30 | | | 350 | 30 | 70 | 70 | 0 | 25 | 5 | 72.5 | 378 | 3.7 | 44.8 | 124 |

As can be seen from Table 1, for the polyamide films made from Solutions 1 to 4, 7 to 9, and 18 to 30, each of which had elastic modulus at 30° C. of 5.0 GPa or less and coefficient of thermal expansion (CTE) of more than 30.0 ppm/K, Rth of each film was reduced to 350 nm or less, and it was smaller than that of the films obtained from other Solutions.

The embodiments have been described, hereinabove. It will be apparent to those skilled in the art that the above methods and apparatuses may incorporate changes and modifications without departing from the general scope of this disclosure. It is intended to include all such modifications and alterations insofar as they come within the scope of the appended claims or the equivalents thereof. Although the description above contains much specificity, this should not be construed as limiting the scope of the disclosure, but as merely providing illustrations of some of the embodiments of this disclosure. Various other embodiments and ramifications are possible within its scope.

Furthermore, notwithstanding that the numerical ranges and parameters setting forth the broad scope of the disclosure are approximations, the numerical values set forth in the specific examples are reported as precisely as possible. Any numerical value, however, inherently contain certain errors necessarily resulting from the standard deviation found in their respective testing measurements.

What is claimed is:

1. A solution of polyamide comprising:
an aromatic polyamide; and
a solvent;
wherein the aromatic polyamide comprises at least two repeat units, and at least one of the repeat units has one or more free carboxyl groups, and
wherein elastic modulus at 30° C. of a cast film formed by applying the solution onto a glass plate is 5.0 GPa or less, and coefficient of thermal expansion (CTE) of the cast film is more than 30.0 ppm/K.

2. The solution according to claim 1, wherein the elastic modulus at 30° C. is 3.5 GPa or less.

3. The solution according to claim 1, wherein retardation (Rth) at 400 nm of thickness direction of a cast film formed by applying the solution onto a glass plate is 350.0 nm or less.

4. The solution according to claim 1, wherein retardation (Rth) at 400 nm of thickness direction of a cast film formed by applying the solution onto a glass plate is 200.0 nm or less.

5. The solution according to claim 1, wherein a ratio of the amount of aromatic monomer components that have a flexible backbone to the total amount of monomer components used for synthesis of the polyamide is 40 mol % or more.

6. The solution according to claim 1, wherein the polyamide comprising:
an aromatic polyamide having repeat units of general formulas (I) and (II): 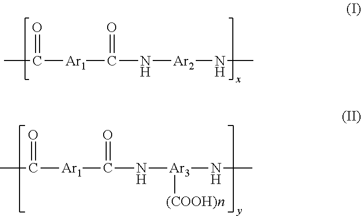
wherein x represents mole % of the repeat structure (I), y represents mole % of the repeat structure (II), x varies from 70 to 99.99, and y varies from 30 to 0.01;
wherein n=1 to 4;
wherein Ar₁ is selected from the group comprising: 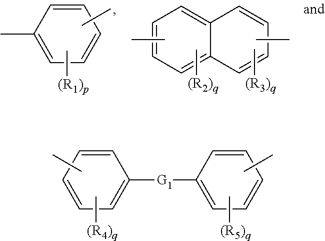
wherein p=4, q=3, and wherein R₁, R₂, R₃, R₄, R₅ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, or substituted aryl such as halogenated aryls, alkyl ester and substituted alkyl esters, and combinations thereof, wherein G₁ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene;
wherein Ar₂ is selected from the group of comprising: 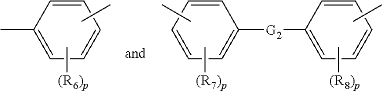
wherein p=4, wherein R₆, R₇, R₈ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, substituted aryl such as halogenated aryls, alkyl ester, and substituted alkyl esters, and combinations thereof, wherein G₂ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene;
wherein Ar₃ is selected from the group comprising: 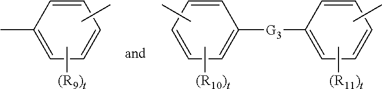
wherein t=1 to 3, wherein R₉, R₁₀, R₁₁ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as halogenated alkoxy, aryl, substituted aryl such as halogenated aryls, alkyl ester, and substituted alkyl esters, and combinations thereof, wherein G₃ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene.

7. The solution according to claim 6, wherein the polyamide contains multiple repeat units of the general formulas (I) and (II), and wherein Ar₁, Ar₂, and Ar₃ are the same or different.

8. The solution according to claim 1, wherein the polyamide is obtained by polymerizing aromatic diacid dichlorides as shown in the following general structures: 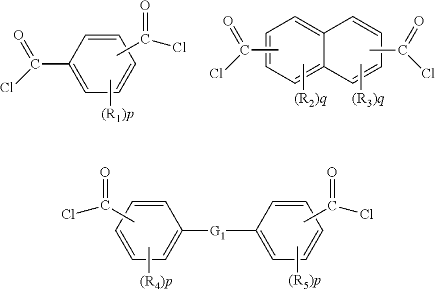
wherein p=4, q=3, and wherein R₁, R₂, R₃, R₄, R₅ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as a halogenated alkoxy, aryl, or substituted aryl such as halogenated aryls, alkyl ester and substituted alkyl esters, and combinations thereof. It is to be understood that each R₁ can be different, each R₂ can be different, each R₃ can be different, each R₄ can be different, and each R₅ can be different. G₁ is selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene.

9. The solution according to claim 1, wherein the polyamide is obtained by polymerizing aromatic diamines as shown in the following general structures: 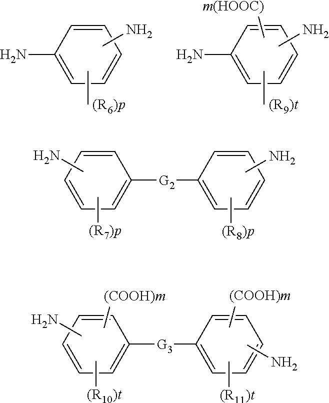
wherein p=4, m=1 or 2, and t=1 to 3, wherein R₆, R₇, R₈, R₉, R₁₀, R₁₁ are selected from the group comprising hydrogen, halogen (fluoride, chloride, bromide, and iodide), alkyl, substituted alkyl such as halogenated alkyls, nitro, cyano, thioalkyl, alkoxy, substituted alkoxy such as a halogenated alkoxy, aryl, substituted aryl such as halogenated aryls, alkyl ester, and substituted alkyl esters, and combinations thereof. It is to be understood that each R₆ can be different, each R₇ can be different, each R₈ can be different, each R₉ can be different, each R₁₀ can be different, and each R₁₁ can be different. G₂ and G₃ are selected from a group comprising a covalent bond; a CH₂ group; a C(CH₃)₂ group; a C(CF₃)₂ group; a C(CX₃)₂ group, wherein X is a halogen; a CO group; an O atom; a S atom; a SO₂ group; a Si(CH₃)₂ group; 9,9-fluorene group; substituted 9,9-fluorene; and an OZO group, wherein Z is an aryl group or substituted aryl group, such as phenyl group, biphenyl group, perfluorobiphenyl group, 9,9-bisphenylfluorene group, and substituted 9,9-bisphenylfluorene.

10. The solution according to claim 1, wherein at least one of terminals of the polyamide is end-capped.

11. The solution according to claim 1, for use in the process for manufacturing a display element, an optical element or an illumination element, comprising the steps of:
a) applying a solution of an aromatic copolyamide onto a base;
b) forming a polyamide film on the base after the applying step (a); and
c) forming the display element, the optical element or the illumination element on the surface of polyamide film,
wherein the base or the surface of the base is composed of glass or silicon wafer.

12. A laminated composite material, comprising a glass plate, and a polyamide resin layer;
wherein the polyamide resin layer is laminated on one surface of the glass plate;
wherein elastic modulus at 30° C. of the polyamide resin layer is 5.0 GPa or less, and coefficient of thermal expansion (CTE) of the cast film is more than 30.0 ppm/K; and
wherein the polyamide resin layer is obtained by applying the solution of polyamide according to claim 1 on the glass plate.

13. The laminated composite material according to claim 12, wherein the elastic modulus at 30° C. is 3.5 GPa or less.

14. The laminated composite material according to claim 12, wherein retardation (Rth) at 400 nm of thickness direction of the polyamide resin layer is 350.0 nm or less.

15. The laminated composite material according to claim 12, wherein retardation (Rth) at 400 nm of thickness direction of the polyamide resin layer is 200.0 nm or less.

16. The laminated composite material according to claim 12, wherein the thickness of the glass plate is 0.3 mm or more.

17. The laminated composite material according to claim 12, wherein the thickness of the polyamide resin is 500 μm or less.

18. The laminated composite material according to claim 12, wherein the total light transmittance at 550 nm of the polyamide resin is 70% or more.

19. A process for manufacturing a display element, an optical element or an illumination element, comprising the step of:
forming the display element, the optical element or the illumination element on a surface of the polyamide resin layer of the laminated composite material according to claim 12, wherein the surface is not opposed to the glass plate.

20. The process according to claim 19, further comprising the step of:
de-bonding, from the glass plate, the display element, the optical element or the illumination element formed on the base.
